(19) United States
(12) Patent Application Publication
(10) Pub. No.: US 2011/0096139 A1
(43) Pub. Date: Apr. 28, 2011

(54) System and Method for Providing Secure Video Visitation

(76) Inventor: James Rudolf, South Milwaukee, WI (US)

(21) Appl. No.: 12/603,837

(22) Filed: Oct. 22, 2009

(51) Int. Cl. H04N 7/14

(52) U.S. Cl. 348/14.11; 348/E07.078

(57) ABSTRACT

A video visitation communication system configured to establish a communication channel using transmittal of simple identifiers. The system includes a plurality of communication stations, each station having a microphone configured to generate an audio signal, a video camera configured to receive the audio signal and generate a combined audio/video signal for transmission, and a display configured to display a received audio/video signal. The system further includes a communication administration station configured to perform steps stored on a computer readable medium to establish a communication channel between the first communication station and the second communication station. The steps include receiving a selection of a first communication station from the plurality of communication stations, receiving a selection of a second communication station from the plurality of communication stations, receiving a selection of parameters for a communication channel between the first and second communication stations, retrieving an identifier for the first and second communication stations, and transmitting an identification message including a simple identifier to each of the communication stations, each simple identifier specifying the other of the communication stations.

### BACKGROUND OF THE INVENTION

This invention relates generally to systems and methods for implementing video visitation where the only contact between individuals is through a video and audio connection. More particularly, the present invention is directed to a system and method for providing connections between two systems chosen from a plurality of systems using simple identifiers to establish communication.

Video visitation communication systems allow communication between two communication stations using audio and video devices. These systems may be used in a correctional facility to allow family and friends to visit with inmates while keeping direct contact to a minimum. Advantageously, the individuals communicating may be separately located such that no direct interaction occurs. This separation allows the correctional facility to avoid many of the difficulties associated with traditional visitation, such as the risk of exchange of contraband, the risk and guard resources required for prisoner transportation and oversight, etc. Other uses may include lawyer/client conferences, arraignment hearings, etc.

The correctional facility may install a number of visitor communication stations in a visitor center. The facility may also install a number of inmate communication stations within the facility. A switch matrix connected to a communication management server may be used to connect any visitor communication station to any inmate communication station. Providing connections between communication stations needs to be simple and quickly completed to allow guards to easily manage visitation.

Video visitation systems are increasingly utilizing more advanced camera systems, such as digital cameras. Some digital cameras, such as internet protocol (IP) cameras, capture a video signal that is converted into individual data packets that are transmitted to a specified web address for display. However, installation and output redirection for IP cameras requires a series of complicated network settings including IP address, a dynamic domain name system (DDNS), router settings and port forwarding. This is very difficult for most users to do alone, without help from an IT technician. Further, this connection may significantly increase the difficulty of quickly creating, severing, and recreating communication channels between any two communication channels. Yet further, each make of IP camera will differ in terms of its specific features and functions, video encoding (compression) schemes, supported network protocols, and the Application Programming Interface to be used by video management software. This information needs to be changed every time an IP camera is reconfigured to transmit data to a new destination.

However, the video visitation communication stations are required to be fairly inaccessible, particularly when used inside a correctional facility, to protect the systems from tampering. These systems typically do not include a keyboard or other interface allowing the systems to be easily reconfigured and are located in secure areas. In spite of this inaccessibility, the communication station camera configuration often needs to be constantly updated based on the particular communication stations to be connected. Yet further, the configuration often is needs to be performed from a third system, for example controlled by a corrections officer, that is located remotely from the two communication stations to be connected.

What is needed is a system and method for providing connections between two communication stations chosen from a plurality of stations using simple identifiers to establish communication. What is further needed is such a system and method providing a user interface allowing a user to establish and change parameters associated with the communication between stations.

### BRIEF DESCRIPTION OF THE INVENTION

The present invention is directed to a video visitation communication system. The system includes a plurality of communication stations, each station having a microphone configured to generate an audio signal, a video camera configured to receive the audio signal and generate a combined audio/video signal for transmission, and a display configured to display a received video signal. The system further includes a communication administration station configured to perform steps stored on, a computer readable medium to establish a communication channel between a first communication station and a second communication station. The steps include receiving a selection of a first communication station from the plurality of communication stations, receiving a selection of a second communication station from the plurality of communication stations, receiving a selection of parameters for a communication channel between the first and second communication stations, retrieving an identifier for the first and second communication stations, and transmitting an identification message including a simple identifier to each of the communication stations, each simple identifier specifying the other of the communication stations.

The present invention is also applicable to systems including a network video recorder and wherein transmitting the combined audio/video signal to the communication station identified in the received communication station includes transmitting the signal to the network video recorder. The present invention is also applicable to systems wherein communication timing is managed by an administration system, which is configured to transmit timing messages to the communication stations.

Various features and advantages of the present invention will be made apparent from the following detailed description taken together with the drawings.

### BRIEF DESCRIPTION OF THE DRAWINGS

The drawings illustrate the best mode presently contemplated of carrying out the invention.

In the drawings:

FIG. 1 is a graphical representation of a video visitation communication system, according to one embodiment of the present invention;

FIG. 2 is a schematic representation of a communication station, according to one embodiment of the present invention;

FIGS. 3A-C are screenshots depicting a user interface for establishing a communication channel using the system of FIG. 1, according to one embodiment of the present invention; and

FIG. 4 is a flowchart illustrating a computer-implemented method for establishing a communication channel using simple identifier transfers to communication stations, according to one embodiment of the present invention.

### DETAILED DESCRIPTION OF THE PREFERRED EMBODIMENT

The present application is directed to a system and method for providing connections between two video and audio communication stations chosen from a plurality of stations using simple identifiers to establish communication. The present application is further directed to a system and method providing a user interface allowing a user to quickly and easily establish and change parameters associated with the communication between the stations.

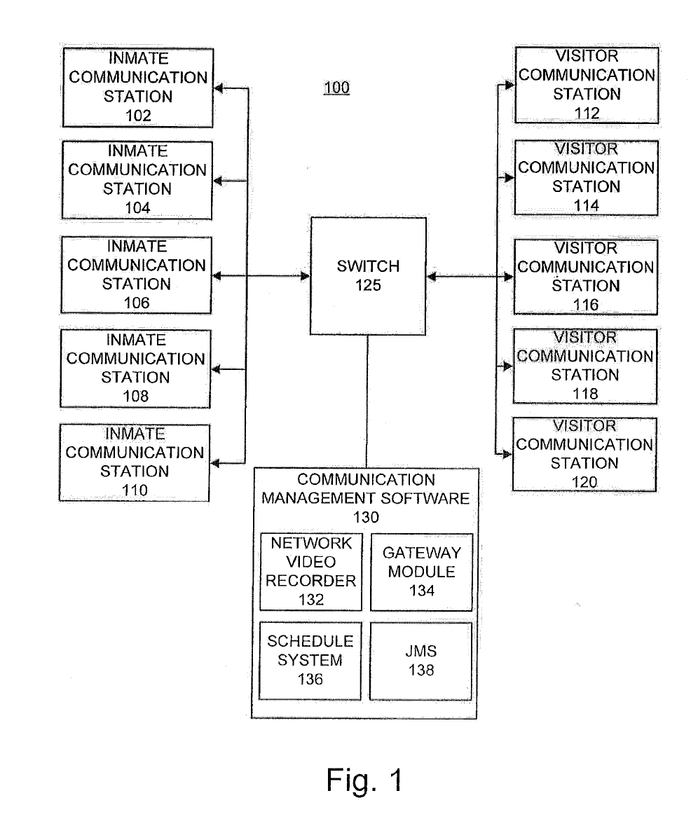

Referring now to FIG. 1, a video visitation communication system 100 is shown, according to an exemplary embodiment. Video visitation communication system includes one or more inmate communication stations 102-110 and one or more visitor communication stations 112-120. Although shown as being generally grouped together, the communication stations may be located in separate locations. For example, visitor communication stations 112-116 may be located in a visitor center located outside the secure area of a correctional facility to allow family members and friends of inmates to conduct visits. Visitor communication station 118 may be located in an area such as a public defenders office to allow inmates of the correctional facility to have meetings with an attorney. Visitor communication station 120 may be located within a courthouse building to allow parole hearings, arraignments, etc. Similarly, inmate communication stations 102-106 may be located within a visitation center for a first cell block and inmate communication stations 108-110 may be located within a visitation center for a second cell block.

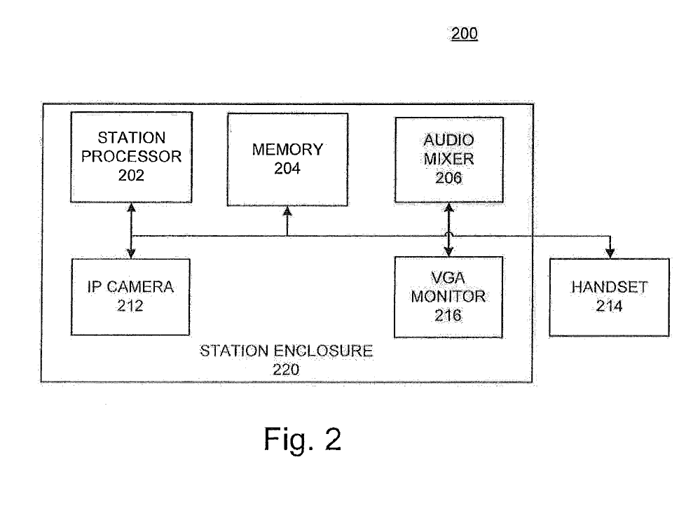

Although system 100 is shown and described with an exemplary number of communication stations and in a number of exemplary locations, it should be understood that any number and/or configuration of communication stations may be utilized to provide the advantages described herein. An exemplary communication station is shown and described in further detail below with reference to FIG. 2.

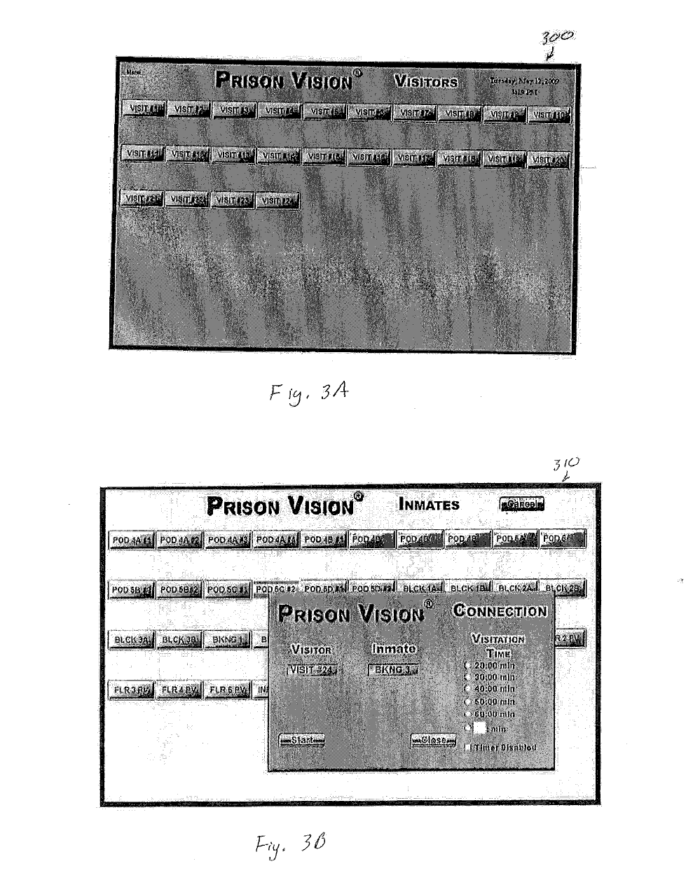

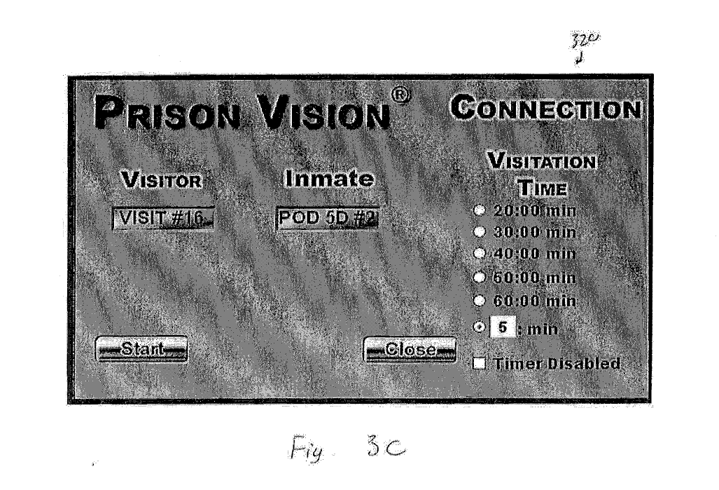

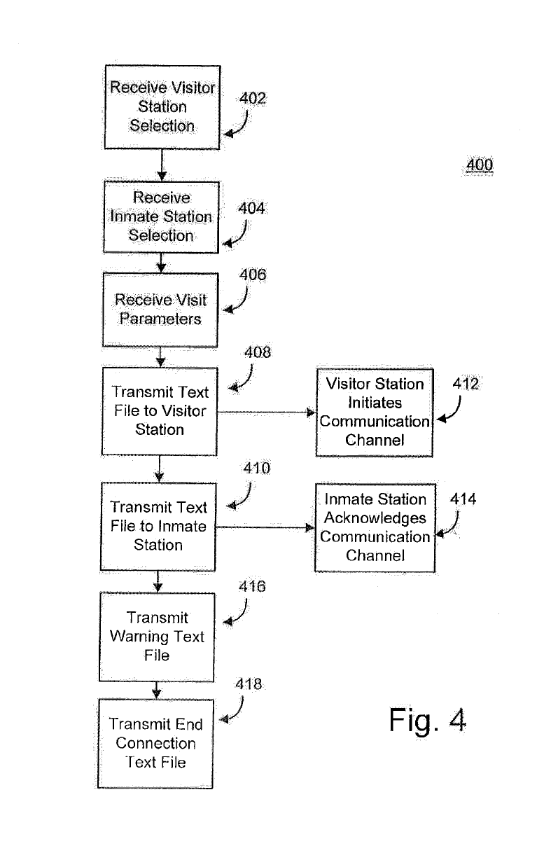

System 100 further includes a station connection switch 125 and a communication administration station 130. Switch 125 may be any type of switch configured to allow video and audio communication between any inmate communication station and any visitor communication station. The connection of communication stations is implemented and managed by communication management software 130 as described in detail below with reference to FIGS. 3 and 4.

System 100 is configured to allow software running on communication administration station 130 to connect any communication station to any other one or more communication stations through switch 125 to allow video and audio communication between the stations. The video and audio communication between the stations is referred to hereinafter as a communication channel.

According to an alternative embodiment, communication administration station 130 may include a network video recorder (NVR) 132. A network video recorder is a digital recording system that receives digital images/video streams over a network and records them on a hard disk in a digital format. Viewing and management of the NVR generally takes place remotely over the network via the administration station 130. Advantageously, NVR 132 may be coupled to switch 125 and configured to receive audio/video signals from both the inmate communication station and the visitor communication station, such that NVR 132 can create a complete video record of the visitation.

According to yet another exemplary embodiment, administration station 130 may include a gateway module 134. Gateway module 134 is configured to enable traditional video conferencing between a system 100 communication station and an external videoconferencing system, such as in a public defenders office, a court arraignment hearing, etc. Gateway 134 may include video conferencing security software such as signal encryption, gateway services, etc.

According to yet another exemplary embodiment, administration station 130 may include a scheduling system 136. Scheduling system 136 may be configured to track planned usages for the communication stations of system 100. Scheduling system 130 may further be configured to automatically initiate a communication channel at a designated time for designated communication stations, to terminate communication channels at designated times, and otherwise perform system functions in accordance with a previously defined schedule.

According to yet another exemplary embodiment, administration station 130 may include a jail management (JMS) system 138. JMS system 138 is configured to allow system 100 to interface with any other video visitation communication system as long as the system is configured to initialize the communication channel initiation steps described hereinbelow.

Although systems 132-138 are shown and described herein as being implemented as components of administration station 130, it should be understood that these systems may be implemented as independent computing systems. For example, scheduling system 130 may be implemented as a separate computing system and configured to send and receive messages to administration station 130 and/or communication stations to implement the scheduling function. Further, any function associated with a described component of system 100 may alternatively be implemented by any other component of system 100.

Referring now to FIG. 2, a schematic representation of a communication station 200 is shown, according to an exemplary embodiment. Communication station 200 may be an inmate communication station or a visitor communication station. Communication station 200 includes a station processor 202, a memory 204, and an audio mixer 206. Input and output for communication station 200 may be implemented using an IP camera 212, a handset 214 and a display monitor 216.

Station processor 202 is configured to receive audio and video input from camera 212 and handset 214, generate a combined audio/video signal including the audio/video input using audio mixer 206, and transmit the combined audio/video signal to switch 125 for subsequent transmission to a specific other communication station to which a communication channel has been established, as discussed in further detail below with reference to FIGS. 3 and 4. Station processor 202 may be any type of computing processor configured to receive instruction from memory 204 and/or any other stored memory and implement one or more of the functions described herein.

For example, station processor 202 may be configured to receive an identification message, which may be an encrypted text file including a communication station identifier from communication administration station 130 in order to initiate a communication channel. Processor 202 is configured to decrypt the text file to determine a communication station identifier. Processor 202 may then open a communication channel with the identified communication station by locally configuring the IP camera 212.

Hard drive 204 may be a hard drive or other memory storage configured to store and allow retrieval of data. Stored data may include a computer program to be executed by processor 202, audio content received through handset 214 and/or any other source, such as a stored file for system messages, video content received from IP camera 212, a combined audio/video signal generated, or audio and video from at least a second communication station connected to communication station 200 through a communication channel. Hard drive 204 may further be configured to store additional information such as communication station identification information, communication channel log information, error logs, etc.

Audio mixer 206 is configured to receive audio signals from handset 214 and convert the received signals from a microphone level to a line level. Converting to a line level allows the audio signal to be received as an audio input at camera 212 to synchronize the received audio with the video signal that matches the received audio. Synchronization is important to provide a consistent audio/video signal, e.g., where a speaker's lips and facial movements match the audio signal. Timing inconsistencies between audio and video signals can be disconcerting for a person viewing the signal at the connected communication station, can impact the evidentiary quality of the generated audio/video signal, etc. Advantageously, by providing the audio signal in a line level as an input to camera 212, station 200 generates a single audio/video signal having minimal timing inconsistency.

Camera 212 may be an IP camera configured to generate a video signal showing the user using stations 200. An IP camera is a closed circuit camera that is configured to use Internet Protocol (IP) to transmit image data and control signals over a Fast Ethernet link. Camera 212 may be a fully digital camera generating a digital image signal. Camera 212 may further be configured to receive the audio signal provided through audio mixer 206.

Advantageously, IP cameras provide numerous advantages over traditional analog closed circuit cameras. IP cameras can provide lower system-wide costs by reducing cabling costs (e.g., using cats cabling as opposed to coaxial cabling), allowing for flexible, higher resolution, image formats that can easily be recorded as digital data, allowing utilization of any number of cameras using the same communication network, etc.

Accordingly, since the camera reconfiguration is performed locally based on the identifier, the difficulties normally associated with IP camera configuration are avoided using the simple identifier method for establishing communication channels as described in detail below with reference to FIG. 4.

Handset 214 may be any type of handset including a speaker providing audio output and a microphone receiving audio input. Although only a single handset is shown, station 200 may alternatively include multiple handsets. Advantageously, multiple handsets may be used in a visitor communication station where an inmate has multiple visitors. Using multiple handsets, each visitor is able to receive the audio output from the inmate side communication station and provide audio input.

Display 216 may be a VGA monitor configured to display a received video image signal transmitted to communication station 200 through a communication channel from another communication station. Display 216 may further display additional information such as a timer showing remaining visit time, a time of day, identification information, etc.

The components of station 200 are typically housed in a secured enclosure 220 to prevent access to the components described herein. An exemplary enclosure 220 may utilize 12 gauge steel housing, a transparent plastic screen through which camera 212 may receive an image to generate the video signal and through which display 216 may display the video signal received over the communication channel. The housing may further include an opening including a door having a tamper-resistant key lock (such as a lock having a triangular form key) to allow access to the components 202-216 for maintenance, upgrading, etc.

Referring now to FIG. 3A, a screenshot depicting a visitor communication station selection screen 300 is shown, according to an exemplary embodiment. Advantageously, screen 300 includes a complete listing of all of the available visitor communication stations for quick and easy selection. Screen 300 may further be configured to include additional information such as time remaining on unavailable communication stations, a map showing station locations, etc.

Referring now to FIG. 3B, a screenshot depicting an inmate communication station selection screen 310 is shown, according to an exemplary embodiment. Similar to visitor selection screen 300, screen 310 includes a complete listing of all of the available inmate communication stations for quick and easy selection. Screen 310 may also further be configured to include additional information such as time remaining on unavailable communication stations, a map showing station locations, etc.

Referring now to FIG. 3C, a screenshot depicting a communication channel parameter selection screen 320 is shown, according to an exemplary embodiment. Screen 320 includes a complete listing of all configurable communication channel parameters for quick and easy selection. Exemplary channel parameters may include visit timing information, a countdown warning display option, a visitation recording option, etc. The options may be configured to include default values such that the normal action will be an acceptance of the default parameters to initiate the communication channel as described below with reference to FIG. 4.

The screenshots shown and described above with reference to FIGS. 3A-3C illustrate that a communication channel may be established using a simple three click process using system 100. Advantageously, a guard sitting in a secure location may use administration station 130 to establish the communication channel at a designated time with minimal effort.

Referring now to FIG. 4, a flowchart 400 illustrating a computer-implemented method for establishing a communication channel using simple identifier transfers to communication stations is shown, according to an exemplary embodiment. The method shown may be implemented by software stored on a computer-readable medium in administration station 130. Although flowchart 400 depicts specific steps being performed in a specific order, it should be understood that the method may be implemented using more, fewer, and/or a different configuration of steps to implement the functionality described herein.

In a step 402, the visitor communication station selection screen 300, described above with reference to FIG. 3A, is displayed on a monitor associated with station 130. A user of system 100, such as a correctional facility officer, uses screen 300 to select a visitor communication station from a listing of available visitor communication stations. The visitor communication station may be selected based on a pre-defined schedule, may be selected automatically by system 100 using scheduling system 136, or according to any other selection method.

In a step 404, the visitor communication station selection screen 310, described above with reference to FIG. 3B, is displayed on a monitor associated with station 130. Again, a user uses screen 310 to select an inmate communication station from a listing of inmate communication stations.

Following selection of the visitor communication station and the inmate communication station that are to be used to establish a communication station, the parameters to be associated with the communication channel may be selected using selection screen 320 in a step 406. Parameter definition may include indicating whether the channel is to be recorded, the duration of the visit, whether a two minute warning is to be provided, etc.

In response to selection of the inmate communication station, station 300 is configured to generate a visitor station text file including a simple identifier, such as the name of the inmate communication station selected in step 402, for transmittal to the visitor communication station to be connected to the named inmate communication station in a step 408. Similarly, in response to selection of the visitor communication station, station 300 is configured to generate an inmate station text file including a simple identifier, such as the name of the visitor communication station selected in step 404, for transmittal to the inmate communication station to be connected to the named visitor communication station in a step 410. The identification messages may be configured to only include a simple identifier, such as a single alphanumeric character string, identifying the relevant communication station. Administration station 130 may be configured to encrypt these text files. Advantageously, transmitting simple encrypted text files allows administration station 130 to quickly and easily establish the communication channel.

In a step 412, the visitor station text file is received at the visitor communication station. The visitor communication station is configured to decrypt the text file to obtain the identifier of the inmate communication station to which a communication channel is to be established. The information necessary to establish the communication channel may be stored locally at each visitor communication channel.

In a step 414, the inmate communication channel similarly receives the inmate station text file. Upon receipt, the inmate communication channel may be configured to wait for a communication channel set up request from the visitor communication channel identified in the inmate station text file.

In a step 416, administration station 130 is configured to transmit a text file including a “Two minute warning” text file message. Upon receipt, each communication station is configured to display a warning message to the station users. Each communication station may further play an audio message indicating the two minute warning. The audio file may be stored locally in each individual communication station. In a step 418, administration station 130 is configured to transmit a text file including a “Terminate Channel” text file. In response, each communication station will close the communication channel. Administration station 130 may also send an alphanumeric message resetting a displayed timer at the communication station where a correctional officer has determined that allowing more or less time is in order.

One skilled in the art will appreciate that the present invention realizes a number of advantages over video visitation systems of the prior art. One such advantage is that the present invention provides for quick and easy communication channel management. In this regard, the present invention may be particularly advantageous for minimizing visitation overhead, training, etc. for the correctional officers of a facility.

While the invention has been shown and described in connection with implementing a video visitation system, it is understood that any video communication system connection may be established using these functions and that video visitation is but one representative embodiment of such a video communication system.

The present invention has been described in terms of the preferred embodiment, and it is recognized that equivalents, alternatives, and modifications, aside from those expressly stated, are possible and within the scope of the appending claims.

We claim:

1. A video communication system, comprising:
a plurality of communication stations, each station including
a microphone configured to generate an audio signal,
a video camera configured to receive the audio signal and generate a combined audio/video signal for transmission, and
a display configured to display a received audio/video signal; and
a communication administration station configured to perform steps stored on a computer readable medium to establish a communication channel between the first communication station and the second communication station, the steps including:
receiving a selection of a first communication station from the plurality of communication stations;
receiving a selection of a second communication station from the plurality of communication stations;
receiving a selection of parameters for a communication channel between the first and second communication stations;
retrieving an identifier for the first and second communication stations; and
transmitting an identification message including the (?) identifier to each of the communication stations, each identifier specifying the other of the communication stations.

2. The communication system of claim 1, wherein the communication station is configured to transmit the combined audio/video signal to the communication station identified in the received identifier.

3. The communication system of claim 2, further including a network video recorder and wherein transmitting the combined audio/video signal to the communication station identified in the received communication station includes transmitting the signal to the network video recorder.

4. The communication system of claim 1, wherein the video camera is an Internet Protocol (IP) camera.

5. The communication system of claim 1, wherein the communication administration station is further configured to start a timer when the identifiers are transmitted and to transmit a timer warning message when the timer has counted down to a specified value.

6. The communication system of claim 5, wherein the communication administration station is further configured to transmit an end communication message when the timer has lapsed.

7. The communication system of claim 1, wherein each communication station further includes a tamper proof enclosure surrounding the components of the communication station.

8. A computer-implemented method, stored on a computer-readable medium, for establishing a communication channel between a first and a second communication station, including:
receiving a selection of the first communication station from the plurality of communication stations;
receiving a selection of the second communication station from the plurality of communication stations;
receiving a selection of parameters for a communication channel between the first and second communication stations;
retrieving an identifier for the first and second communication stations from a memory; and
transmitting an identification message to each of the communication stations, each message including the identifier of the other of the communication stations.

9. The method of claim 8, further including transmitting the combined audio/video signal to the communication station identified in the received identification message.

10. The method of claim 9, further including transmitting the combined audio/video signal to a network video recorder.

11. The method of claim 8, further including
starting a timer when the identification messages are transmitted, and
transmitting a timer warning message when the timer has counted down to a specified value.

12. The method of claim 11, further including transmitting an end communication message when the timer has lapsed.

13. A video visitation communication station, comprising:
a microphone configured to generate an audio signal;
a video camera configured to receive the audio signal and generate a combined audio/video signal for transmission;
a display configured to display a received audio/video signal; and
communication channel management software configured to perform steps stored on a computer readable medium to establish a communication channel between the communication station and a second communication station, the steps including:
receiving an identification message including an alphanumeric identifier of the second communication stations; and
generating a communication channel based on the received identification message.

14. The communication station of claim 13, wherein the communication channel management software is further configured to transmit the combined audio/video signal to the second communication station identified in the received identification message.

15. The communication station of claim 14, wherein the communication channel management software is further configured to transmit the audio/video signal to a network video recorder.

16. The communication station of claim 13, wherein the video camera is an Internet Protocol (IP) camera.

17. The communication station of claim 13, wherein the communication channel management software is further configured to display a warning message upon receipt of a timer warning message.

18. The communication station of claim 13, wherein the communication channel management software is further configured to terminate communication with the second communication station upon receipt of an end communication message.

19. The communication station of claim 13, further including a tamper proof enclosure surrounding the components of the communication station.
